(19) United States
(12) Patent Application Publication
(10) Pub. No.: US 2025/0301307 A1
(43) Pub. Date: Sep. 25, 2025

(54) COMMUNICATION METHOD FOR SENSING SESSION ESTABLISHMENT, AND COMMUNICATION APPARATUS

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/863,511

(22) PCT Filed: May 6, 2022
(86) PCT No.: PCT/CN2022/091196

§ 371 Date: Nov. 6, 2024

(51) Int. Cl. H04W 8/22; H04L 1/00; H04L 27/20; H04L 41/0896

(52) U.S. Cl. CPC H04W 8/22; H04L 1/0003; H04L 27/2067; H04L 41/0896

(57) ABSTRACT

A communication method for a sensing session setup. The method includes: determining a first message frame, wherein the first message frame comprises capability information on sensing measurement parameters supported by a device performing the communication method; and transmitting the first message frame.

### CROSS-REFERENCE TO RELATED APPLICATION

This application is the U.S. national phase application of International Application No. PCT/CN2022/091196, filed on May 6, 2022, the disclosure of which is incorporated herein by reference in its entirety for all purposes.

### TECHNICAL FIELD

The present disclosure relates to the field of wireless communications, and in particular, to a communication method and a communication apparatus for a sensing session setup.

### BACKGROUND

A wireless local area network (WLAN) has advantages such as flexibility, mobility and low cost. With the development of communication technologies and the growth of user needs, the application research for the WLAN is gradually deepening. For example, WLAN sensing is currently being studied, whose main application scenarios include a location discovery in a dense environment (e.g., a home environment or a company environment), a proximity detection, a presence detection, etc.

### SUMMARY

Various examples of the present disclosure provide the following technical solutions.

According to an example of the present disclosure, a communication method for a sensing session setup is provided. The communication method includes: determining a first message frame, wherein the first message frame includes capability information on sensing measurement parameters supported by a device performing the communication method; and transmitting the first message frame.

According to an example of the present disclosure, a communication method for a sensing session setup is provided. The communication method includes: receiving a first message frame, wherein the first message frame includes capability information on sensing measurement parameters supported by a device transmitting the first message frame; and taking one or more operations of a sensing measurement based on the first message frame.

According to an example of the present disclosure, an electronic device is provided. The electronic device includes one or more memories, one or more processors, and a computer program stored on the one or more memories and executable on the one or more processors. The one or more processors are configured to determine a first message frame, wherein the first message frame includes capability information on sensing measurement parameters supported by the electronic device; and transmit the first message frame.

According to the technical solutions provided by the examples of the present disclosure, the capability information on sensing measurement parameters supported by the device is improved during a sensing session setup procedure, so as to be suitable for a wireless local area network (WLAN) sensing measurement.

### BRIEF DESCRIPTION OF THE DRAWINGS

The described and other features of examples of the present disclosure will become more apparent by describing the examples of the present disclosure in detail with reference to the accompanying drawings.

FIG. 1A to FIG. 1C illustrate examples of WLAN sensing modes.

FIG. 2 illustrates a flowchart of a communication method for a sensing session setup according to an example.

FIG. 3 illustrates a flowchart of interactive communications between an initiator and a responder according to an example.

FIG. 4 illustrates a flowchart of interactive communications between an initiator and a responder according to an example.

FIG. 5 illustrates a flowchart of interactive communications between an initiator and a responder according to an example.

FIG. 6 illustrates a flowchart of interactive communications between an initiator and a responder according to an example.

FIG. 7 illustrates a flowchart of another communication method according to an example.

FIG. 8 illustrates a block diagram of a communication apparatus according to an example.

### DETAILED DESCRIPTION OF THE EMBODIMENTS

The following description with reference to the accompanying drawings is provided to assist in a full understanding of various examples of the present disclosure as defined by the appended claims and their equivalents. Various examples of the present disclosure include various specific details. However, these specific details are regarded as examples only. Furthermore, descriptions of well-known technologies, functions, and constructions may be omitted for clarity and conciseness.

The terms and words used in the present disclosure are not limited to their literal meanings, but are specifically used by the inventor to enable a clear and consistent understanding of the present disclosure. Therefore, for those skilled in the art, the description of various examples of the present disclosure is provided for illustrative purposes only and not for limiting purposes.

It is to be understood that terms defined herein by “a”, “one”, “said” and “the” in their singular forms may also include their plural forms, unless clearly indicated otherwise in the context. It is further to be understood that the term “comprising” as used in the present disclosure refers to the presence of the described feature, integer, step, operation, element and/or component, but does not exclude the presence or addition of one or more other features, integers, steps, operations, elements, components and/or a combination thereof.

Although terms “first,” “second,” and the like may be used in the present disclosure to describe various elements, it is to be understood that these elements should not be limited to these terms. These terms are only used to distinguish one element with another element. Thus, without departing from the teachings of the examples, the first element discussed below may be referred to as the second element.

When a component is referred to as being “connected” or “coupled” to another component, it is to be understood that the component may be directly connected or coupled to another component, or that one or more intermediate components may be present. Furthermore, being “connected” or “coupled” as used herein may include being wirelessly connected or being wirelessly coupled. The term “and/or” or the expression “at least one of . . . ” as used herein includes any or all combinations of one or more associated listed items.

Unless otherwise defined, all terms (including technical and scientific terms) used herein have the same meaning as commonly understood by one of ordinary skill in the art to which the present disclosure belongs.

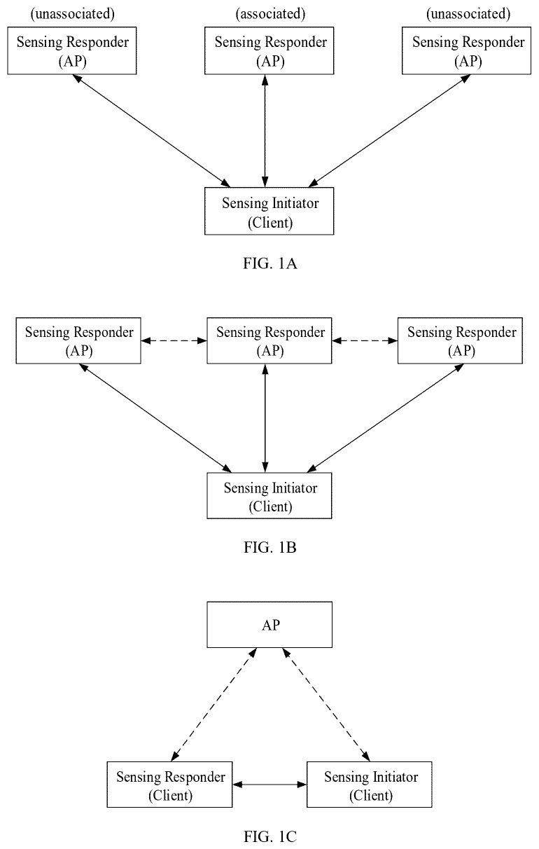

FIG. 1A to FIG. 1C illustrate examples of wireless local area network (WLAN) sensing modes.

A WLAN sensing process may include: an initiator initiates a WLAN sensing procedure (for example, it initiates a WLAN sensing session), and there may be multiple responders responding to it. The specific possible modes may be illustrated as FIG. 1A, FIG. 1B and FIG. 1C.

Referring to FIG. 1A, when the WLAN sensing initiator (e.g., a client) initiates the WLAN sensing procedure, multiple associated or unassociated WLAN sensing responders (e.g., three access points (APs)) may respond it. Being “associated” may refer to that an associated connection for communications is established between the initiator and the responder, while being “unassociated” may refer to that no associated connection for communications is established between the initiator and the responder.

As an example, the client may include, but is not limited to, a cellular phone, a smart phone, a wearable device, a computer, a personal digital assistant (PDA), a personal communication system (PCS) device, a personal information manager (PIM), a personal navigation device (PND), a global positioning system, a multimedia device, an Internet of Things (IoT) device, etc.

The AP may be a wireless switch applied in a wireless network or an access device for the wireless network. The AP may include software applications and/or circuits to enable other types of nodes in the wireless network to communicate externally and internally to the wireless network through the AP. As an example, the AP may be a terminal device or a network device equipped with a wireless fidelity (Wi-Fi) chip.

FIG. 1B is similar to FIG. 1A. However, in FIG. 1B, all the responders (APs) may communicate with each other.

Referring to FIG. 1C, both the WLAN sensing initiator and the WLAN sensing responder may be the clients, and the two may communicate by connecting to the same AP.

Although FIG. 1A, FIG. 1B and FIG. 1C illustrate the case where the client acts as the initiator and the AP acts as the responder, the present disclosure is not limited thereto. For example, the AP may act as the initiator and the client may act as the responder in various examples of the present disclosure. Furthermore, the client may also be referred to as a non-AP station (STA), or a STA for short, in various examples of the present disclosure. In addition, the number of the initiators and the number of the responders are not limited to those illustrated in FIG. 1A, FIG. 1B and FIG. 1C.

In the WLAN sensing procedure, there may be two stages, a sensing session setup and a sensing measurement setup. The sensing session is a negotiation session/session negotiation between the sensing initiator and the sensing responder participating in the WLAN sensing procedure. During the sensing session setup in the WLAN sensing procedure, a sensing session is established, and measurement parameters associated with the sensing session may be determined and exchanged between the devices. During the sensing measurement setup, it may perform a sensing measurement and/or report a measurement result.

Different sensing measurements may have different sensing measurement requirements. The process of the sensing session setup is a process of interacting capability information on sensing measurement parameters between the initiator and the responder, so that the sensing measurements that meet different requirements are established based on the interacted capability information on sensing measurement parameters during the sensing measurement setup. However, the existing standards do not define what capability about sensing measurement parameters is supported by the device or what signaling is configured to identify the capability information on sensing measurement parameters, which needs to be improved.

In view of this, according to the concept of the examples of the present disclosure, a communication method and a communication apparatus for the sensing session setup are provided.

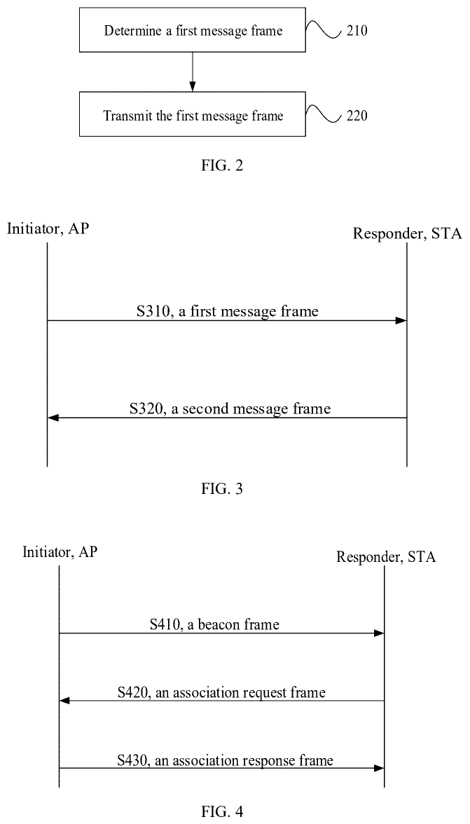

FIG. 2 illustrates a flowchart of a communication method for a sensing session setup according to an example. The communication method illustrated in FIG. 2 may be applied to an initiator or a responder of a WLAN sensing procedure. That is, the communication method illustrated in FIG. 2 may be performed by the initiator or the responder.

Referring to FIG. 2, at step 210, a first message frame is determined. The first message frame may include capability information on sensing measurement parameters supported by the device performing the communication method.

In the example of the present disclosure, there may be many ways to determine the first message frame. For example, the first message frame may be generated or configured based on at least one of the following: a channel status, a network condition, a load condition, a hardware capability of the device, a service type, or a relevant protocol provision, which is not specifically limited in the present disclosure. In the example of the present disclosure, the first message frame may also be obtained from an external device, which is not specifically limited in the present disclosure.

According to the example of the present disclosure, the first message frame may include at least one of the following: bandwidth information supported by the device; information on a number of spatial streams supported by the device; modulation and coding scheme (MCS) information supported by the device; or transceiving capability information supported by the device.

Various types of information included in the first message frame is described in various examples herein.

In an example of the present disclosure, the bandwidth information supported by the device may include: minimum bandwidth information and/or maximum bandwidth information supported by the device for a sensing measurement. For example, the minimum bandwidth information and/or the maximum bandwidth information may be a bandwidth used during the sensing measurement or during reporting a sensing measurement result. For example, a sensing measurement frame used during the sensing measurement may be designed based on the bandwidth information supported by the device, for example, a null data packet (NDP) frame.

As a non-limiting example, the minimum bandwidth information may refer to 20 MHZ, and the maximum bandwidth information may refer to 320 MHz. However, the present disclosure is not limited thereto. The minimum bandwidth information and/or the maximum bandwidth information may be determined among bandwidth sizes such as 20 MHz, 40 MHz, 80 MHz, 160 MHz and 320 MHz based on a hardware capability of the device or relevant protocol/standard provisions. In addition, one bit may be adopted in the first message frame to identify the minimum bandwidth information supported by the device (e.g., 20 MHz). For example, when the bit is set to a first value (e.g., but not limited to, 1), it may be identified that the device supports the sensing measurement with the minimum bandwidth of 20 MHz. However, it is merely exemplary, and the present disclosure is not limited thereto. For example, two or more bits may be adopted to identify the minimum bandwidth information supported by the device. In addition, multiple bits (for example, three bits) may be adopted in the first message frame to identify the maximum bandwidth information supported by the device (e.g., 320 MHz). For example, when the three bits are set to a second value (e.g., but not limited to, 111), it may be identified that the device supports the sensing measurement with the maximum bandwidth of 320 MHz. However, it is merely exemplary, and the present disclosure is not limited thereto. For example, less or more bits may be adopted to identify the maximum bandwidth information supported by the device.

In an example of the present disclosure, the information on a number of spatial streams supported by the device may include: a minimum number of spatial streams (NSS) and/or a maximum number of spatial streams supported by the device for the sensing measurement. For example, the minimum NSS and/or the maximum NSS may be an NSS used during the sensing measurement or during reporting the sensing measurement result. For example, a sensing measurement frame used during the sensing measurement may be designed based on the NSS supported by the device, for example, an NDP frame.

As a non-limiting example, the minimum NSS may be 1, and the maximum NSS may be 16 or 8, but the present disclosure is not limited thereto. The NSS of other sizes are also included within the scope of the present disclosure. One bit may be adopted in the first message frame to identify the supported minimum NSS. For example, when the bit is set to a first value (e.g., but not limited to, 1), it may be identified that the device supports the sensing measurement with the minimum NSS of 1. However, it is merely exemplary, and the present disclosure is not limited thereto. For example, two or more bits may be adopted to identify the minimum NSS supported by the device. Multiple bits (for example, four bits) may be adopted in the first message frame to identify the supported maximum NSS. For example, when the four bits are set to a third value (e.g., but not limited to, 1111), it may be identified that the device supports the sensing measurement with the maximum NSS of 16. For example, when the four bits are set to a fourth value (e.g., but not limited to, 0111), it may be identified that the device supports the sensing measurement with the maximum NSS of 8. However, it is merely exemplary, and the present disclosure is not limited thereto. For example, less or more bits may be adopted to identify the maximum NSS supported by the device.

In an example of the present disclosure, the MCS information supported by the device may be associated with the bandwidth information supported by the device. An index value of the MCS may be set in the first message frame to identify transmission resources that the device may support for use in the sensing measurement. For example, the MCS identified by the index value may include various parameters corresponding to the transmission resources, such as an NSS, a modulation mode and a rate. The MCSs under different bandwidths may be different, and therefore, the MCS included in the first message frame may be associated with the bandwidth supported by the device.

In an example of the present disclosure, the transceiving capability information supported by the device may refer to 4096-quadrature amplitude modulation (QAM), 1024-QAM, 256-QAM, 64-QAM, 16-QAM, quadrature phase shift keying (QBSK) and/or binary phase shift keying (BPSK) transceiving capabilities supported by the device under different resource unit (RU) allocations. For example, the transceiving capability information supported by the device may refer to 4096-QAM, 1024-QAM, 256-QAM, 64-QAM, 16-QAM, QBSK and/or BPSK transceiving capabilities supported by the device under a minimum bandwidth (e.g., 20 MHz). However, the present disclosure is not limited thereto. The transceiving capability information supported by the device may also refer to the transceiving capabilities of the device in various modulation modes under other bandwidths. As a non-limiting example, the RU may be a single resource unit (SRU) or a multiple resource unit (MRU) of various sizes such as 26-tone, 52-tone, 106-tone, 52+26-tone and 106+26-tone. For example, through the transceiving capability information supported by the device, it may be identified in the first message frame whether the device supports a 4096-QAM transmission, a 4096-QAM reception, a 1024-QAM transmission, a 1024-QAM reception, a 256-QAM transmission, a 256-QAM reception, a 64-QAM transmission, a 64-QAM reception, a 16-QAM transmission, a 16-QAM reception, a QBSK transmission, a QBSK reception, a BPSK transmission, and/or a BPSK reception. For example, one or more bits may be adopted to identify the transceiving capability information supported by the device. For example, when the device is the initiator, it may be identified in the first message frame that the initiator supports the 4096-QAM transmission, the 1024-QAM transmission, the 256-QAM transmission, the 64-QAM transmission, the 16-QAM transmission, the QBSK transmission, and/or the BPSK transmission. When the device is the responder, it may be identified in the first message frame that the initiator supports the 4096-QAM reception, the 1024-QAM reception, the 256-QAM reception, the 64-QAM reception, the 16-QAM reception, the QBSK reception, and/or the BPSK reception.

At step 220, the first message frame is transmitted. When the communication method of FIG. 2 is applied to the initiator, the initiator may transmit the first message frame to the responder in step 220, and the capability information on sensing measurement parameters included in the first message frame in step 210 may refer to the capability about sensing measurement parameters of the initiator. When the communication method of FIG. 2 is applied to the responder, the responder may transmit the first message frame to the initiator in step 220, and the capability information on sensing measurement parameters included in the first message frame in step 210 may refer to the capability about sensing measurement parameters of the responder.

In the example of the present disclosure, the first message frame may have different forms according to the communication stage in which the sensing session setup occurs. For example, the first message frame may be a frame in a probe or association stage, such as a beacon frame, an association request frame, an association response frame, or a probe response frame. Alternatively, the first message frame may be a newly defined sensing session setup frame or a sensing session notification frame, etc. For example, considering security and privacy, the first message frame may be a newly defined frame transmitted after the initiator and the responder complete a key negotiation (for example, through a four-step handshake). More detailed descriptions will be given later in conjunction with FIG. 4 to FIG. 6.

FIG. 3 illustrates a flowchart of interactive communications between an initiator and a responder according to an example. In FIG. 3, as a non-limiting example, the initiator may be an AP and the responder may be a STA.

Referring to FIG. 3, in step S310, the AP as the initiator may transmit a first message frame to the STA as the responder. The first message frame may include capability information on sensing measurement parameters supported by the AP as the initiator. For example, the first message frame may include at least one of bandwidth information supported by the AP as the initiator, information on a number of spatial streams supported by the AP as the initiator, modulation and coding scheme information supported by the AP as the initiator, or transceiving capability information supported by the AP as the initiator. The STA as the responder may parse the received first message frame and obtain the capability information on sensing measurement parameters of the AP as the initiator. The bandwidth information, the information on a number of spatial streams, the modulation and coding scheme information, and the transceiving capability information have been described with reference to the various examples of FIG. 2, which are not repeated here for the sake of brevity. In addition, as a descriptive example only, the described capability information on sensing measurement parameters supported by the AP as the initiator may be carried in the first message frame in the form of a sensing session information element.

Still referring to FIG. 3, in step S320, the STA as the responder may transmit a second message frame to the AP as the initiator. The second message frame may include capability information on sensing measurement parameters supported by the STA as the responder. For example, the second message frame may include at least one of bandwidth information supported by the STA as the responder, information on a number of spatial streams supported by the STA as the responder, modulation and coding scheme information supported by the STA as the responder, or transceiving capability information supported by the STA as the responder. The AP as the initiator may parse the received second message frame and obtain the capability information on sensing measurement parameters of the STA as the responder. The bandwidth information, the information on a number of spatial streams, the modulation and coding scheme information, and the transceiving capability information have been described with reference to the various examples of FIG. 2, which are not repeated here for the sake of brevity. In addition, as a descriptive example only, the described capability information on sensing measurement parameters supported by the STA as the responder may be carried in the second message frame in the form of a sensing session information element.

During establishing a sensing measurement session, the AP as the initiator and the STA as the responder are to identify their supported capability information on sensing measurement parameters to each other, so that their capability information may be used during the subsequent sensing measurement or during reporting a sensing measurement result to implement the sensing measurement under different requirements.

In the example of the present disclosure, the first message frame and the second message frame may have different forms according to the communication stage in which a sensing session setup occurs.

FIG. 4 illustrates a flowchart of interactive communications for establishing a sensing measurement session when an AP transmits a beacon frame to establish an association connection between the AP and a STA.

Referring to FIG. 4, at S410, the AP may broadcast the beacon frame to the STA, where the beacon frame may include capability information on sensing measurement parameters supported by the AP. In other words, the beacon frame may correspond to the first message frame in FIG. 2 and FIG. 3. For example, the beacon frame may include at least one of bandwidth information supported by the AP, information on a number of spatial streams supported by the AP, modulation and coding scheme information supported by the AP, or transceiving capability information supported by the AP. The capability information on sensing measurement parameters supported by the AP may be encrypted in the beacon frame to ensure communication security. The STA may parse the received beacon frame and obtain the capability information on sensing measurement parameters of the AP. The bandwidth information, the information on a number of spatial streams, the modulation and coding scheme information, and the transceiving capability information have been described with reference to the various examples of FIG. 2, respectively, which are not repeated here for the sake of brevity.

At S420, the STA may transmit an association request frame to the AP, where the association request frame may include capability information on sensing measurement parameters supported by the STA. In other words, the association request frame may correspond to the second message frame in FIG. 3. For example, the association request frame may include at least one of bandwidth information supported by the STA, information on a number of spatial streams supported by the STA, modulation and coding scheme information supported by the STA, or transceiving capability information supported by the STA. The AP may parse the received association request frame and obtain the capability information on sensing measurement parameters of the STA. The bandwidth information, the information on a number of spatial streams, the modulation and coding scheme information, and the transceiving capability information have been described with reference to the various examples of FIG. 2, respectively, which are not repeated here for the sake of brevity.

At S430, the AP may transmit an association response frame to the STA, so as to establish the association connection between the AP and the STA.

In FIG. 4, the AP and the STA may complete the exchange of the capability information on sensing measurement parameters for the sensing measurement during the association establishment stage, thereby saving signaling and being applicable to a WLAN sensing measurement. In addition, although only one STA is illustrated in FIG. 4, it is only for the sake of concise description and is not a limitation of the present disclosure. For example, the AP may broadcast beacon frames to multiple STAs, so that the exchange of capability information on sensing measurement parameters supported by the devices for the sensing session setup are implemented during the stage of establishing the associations with the multiple STAs.

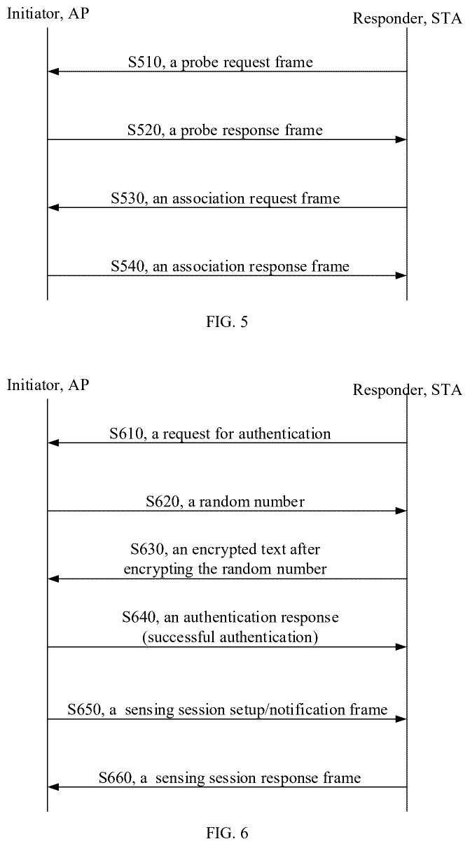

FIG. 5 illustrates a flowchart of interactive communications for establishing a sensing measurement session when a STA transmits a probe request frame to establish an association connection between an AP and the STA.

Referring to FIG. 5, at S510, the STA may transmit the probe request frame to the AP. At S520, the AP may reply with a probe response frame to the STA, where the probe response frame may include capability information on sensing measurement parameters supported by the AP. In other words, the probe response frame may correspond to the first message frame in FIG. 2 and FIG. 3. For example, the probe response frame may include at least one of bandwidth information supported by the AP, information on a number of spatial streams supported by the AP, modulation and coding scheme information supported by the AP, or transceiving capability information supported by the AP. The STA may parse the received probe response frame and obtain the capability information on sensing measurement parameters of the AP. The bandwidth information, the information on a number of spatial streams, the modulation and coding scheme information, and the transceiving capability information have been described with reference to the various examples of FIG. 2, respectively, which are not repeated here for the sake of brevity.

At S530, the STA may transmit an association request frame to the AP, where the association request frame may include capability information on sensing measurement parameters supported by the STA. In other words, the association request frame may correspond to the second message frame in FIG. 3. For example, the association request frame may include at least one of bandwidth information supported by the STA, information on a number of spatial streams supported by the STA, modulation and coding scheme information supported by the STA, or transceiving capability information supported by the STA. The AP may parse the received association request frame and obtain the capability information on sensing measurement parameters of the STA. The bandwidth information, the information on a number of spatial streams, the modulation and coding scheme information, and the transceiving capability information have been described with reference to the various examples of FIG. 2, respectively, which are not repeated here for the sake of brevity.

At S540, the AP may transmit an association response frame to the STA, so as to establish the association connection between the AP and the STA.

In FIG. 5, the AP and the STA may complete the exchange of the capability information on sensing measurement parameters for the sensing measurement during the association establishment stage, thereby saving signaling and being applicable to a WLAN sensing measurement. In addition, although FIG. 5 illustrates that the AP carries the capability information on sensing measurement parameters supported by the AP in the probe response frame and that the STA carries the capability information on sensing measurement parameters supported by the STA in the association request frame, it is to be understood that it is merely exemplary, and the respective capability information may also be carried in other frames in the case where the security of communication can be guaranteed.

FIG. 6 illustrates a flowchart of interactive communications for establishing a sensing measurement session after an AP and a STA complete a four-step handshake.

Referring to FIG. 6, the AP and the STA may implement the four-step handshake through S610 to S640, thereby completing a key negotiation between the devices. At Step 610, the STA transmits a request for authentication to the AP. At Step 620, the AP transmits a random number to the STA. At S630, the STA transmits an encrypted text after encrypting the random number to the AP. At S640, the AP transmits an authentication response to the STA, which indicates a successful authentication.

At S650, the AP may transmit a newly defined sensing session setup frame or sensing session notification frame to the STA, where the sensing session setup frame or the sensing session notification frame may include capability information on sensing measurement parameters supported by the AP. In other words, the sensing session setup frame or the sensing session notification frame may correspond to the first message frame in FIG. 2 and FIG. 3. For example, the sensing session setup frame or the sensing session notification frame may include at least one of bandwidth information supported by the AP, information on a number of spatial streams supported by the AP, modulation and coding scheme information supported by the AP, or transceiving capability information supported by the AP. The STA may parse the received sensing session setup frame or sensing session notification frame, and obtain the capability information on sensing measurement parameters of the AP. The bandwidth information, the information on a number of spatial streams, the modulation and coding scheme information, and the transceiving capability information have been described with reference to the various examples of FIG. 2, respectively, which are not repeated here for the sake of brevity.

At S660, the STA may transmit a sensing session response frame to the AP, where the sensing session response frame may include the capability information on sensing measurement parameters supported by the STA. In other words, the sensing session response frame may correspond to the second message frame in FIG. 3. For example, the sensing session response frame may include at least one of bandwidth information supported by the STA, information on a number of spatial streams supported by the STA, modulation and coding scheme information supported by the STA, or transceiving capability information supported by the STA. The AP may parse the received sensing session response frame and obtain the capability information on sensing measurement parameters of the STA. The bandwidth information, the information on a number of spatial streams, the modulation and coding scheme information, and the transceiving capability information have been described with reference to the various examples of FIG. 2, respectively, which are not repeated here for the sake of brevity.

In FIG. 6, the AP and the STA exchange the capability information on sensing measurement parameters after completing the four-step handshake, thereby ensuring the privacy and security of the sensing measurement.

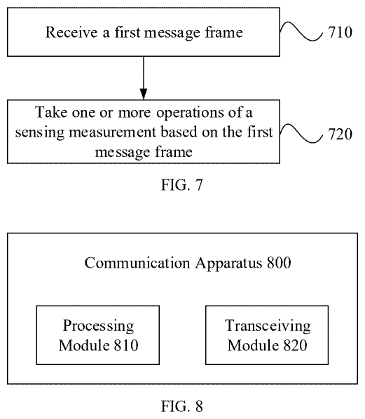

FIG. 7 illustrates a flowchart of another communication method according to an example. The communication method illustrated in FIG. 7 may be applied to a responder or an initiator. For example, in the case where the communication method of FIG. 2 is performed by the initiator, the communication method of FIG. 7 may be performed by the responder. In the case where the communication method of FIG. 2 is performed by the responder, the communication method of FIG. 7 may be performed by the initiator.

Referring to FIG. 7, at step 710, a first message frame is received. The first message frame includes capability information on sensing measurement parameters supported by the device transmitting the first message frame. For example, in the case where the communication method of FIG. 2 is performed by the initiator and the communication method of FIG. 7 may be performed by the responder, the first message frame may include the capability information on sensing measurement parameters supported by the initiator. For example, in the case where the communication method of FIG. 2 is performed by the responder and the communication method of FIG. 7 may be performed by the initiator, the first message frame may include the capability information on sensing measurement parameters supported by the responder.

Alternatively, or additionally, the first message frame may include at least one of the following: bandwidth information supported by the device transmitting the first message frame; information on a number of spatial streams supported by the device transmitting the first message frame; modulation and coding scheme information supported by the device transmitting the first message frame; or transceiving capability information supported by the device transmitting the first message frame.

Alternatively, or additionally, the bandwidth information supported by the device transmitting the first message frame may include: minimum bandwidth information and/or maximum bandwidth information supported by the device for a sensing measurement.

Alternatively, or additionally, the information on a number of spatial streams supported by the device transmitting the first message frame may include: a minimum number of spatial streams and/or a maximum number of spatial streams supported by the device for the sensing measurement.

Alternatively, or additionally, the modulation and coding scheme information supported by the device transmitting the first message frame may be associated with the bandwidth information supported by the device.

Alternatively, or additionally, the transceiving capability information supported by the device transmitting the first message frame may refer to 4096-QAM, 1024-QAM, 256-QAM, 64-QAM, 16-QAM, QBSK and/or BPSK transceiving capabilities supported by the device under different resource unit allocations.

The bandwidth information, the information on a number of spatial streams, the modulation and coding scheme information, and the transceiving capability information have been described with reference to the various examples of FIG. 2, respectively, which are not repeated here for the sake of brevity.

At step 720, one or more operations of the sensing measurement are performed based on the first message frame. For example, in the case where the communication method of FIG. 2 is performed by the initiator and the communication method of FIG. 7 may be performed by the responder, the responder may determine and transmit a second message frame (as described in FIG. 3) in step 720, so that the initiator obtains the capability information on sensing measurement parameters supported by the responder. For example, in the case where the communication method of FIG. 2 is performed by the responder and the communication method of FIG. 7 may be performed by the initiator, the initiator may initiate a sensing measurement establishment in step 720, thereby performing the operations of the sensing measurement and/or operations of reporting the sensing measurement result between the initiator and the responder.

FIG. 8 illustrates a block diagram of a communication apparatus according to an example. The communication apparatus 800 in FIG. 8 may include a processing module 810 and a transceiving module 820.

In an example of the present disclosure, the processing module 810 illustrated in FIG. 8 may be configured to determine a first message frame. The first message frame may include capability information on sensing measurement parameters supported by a device to which the communication apparatus is applied. The transceiving module 820 may be configured to transmit the first message frame. That is, the communication apparatus 800 illustrated in FIG. 8 may be applied to the device transmitting the first message frame. The communication method described with reference to FIG. 2 may be performed and applied thereto. To avoid redundancy, repeated descriptions are omitted here.

In another example of the present disclosure, the transceiving module 820 may be configured to receive a first message frame. The first message frame may include capability information on sensing measurement parameters supported by a device transmitting the first message frame. The processing module 810 may be configured to control one or more operations of a sensing measurement based on the first message frame. That is, the communication apparatus 800 illustrated in FIG. 8 may be applied to the device receiving the first message frame and perform the communication method described with reference to FIG. 7. To avoid redundancy, repeated descriptions are omitted here.

It is to be understood that the communication apparatus 800 illustrated in FIG. 8 is merely exemplary, and the examples of the present disclosure are not limited thereto. For example, the communication apparatus 800 may further include other modules such as a memory module. Furthermore, the various modules in the communication apparatus 800 may be combined into a more complex module, or may be divided into more separate modules.

The communication methods and the communication apparatuses according to the examples of the present disclosure improve the capability information on sensing measurement parameters supported by the device during the sensing session setup, and make it suitable for the WLAN sensing measurement.

Based on the same principle as the methods provided by the examples of the present disclosure, an example of the present disclosure also provides an electronic device, which includes one or more processors and one or more memories. The one or more memories stores machine-readable instructions (also referred to as “a computer program”). The one or more processors are configured to execute the machine-readable instructions to implement the method described with reference to FIG. 2 to FIG. 7.

An example of the present disclosure further provides a non-transitory computer-readable storage medium, with a computer program stored thereon. The computer program, when executed by one or more processors, implements the methods described with reference to FIG. 2 to FIG. 7.

In an example, the processor may be configured to implement or execute various illustrative logic blocks, modules, and circuits described in conjunction with the present disclosure, such as a central processing unit (CPU), a general-purpose processor, a digital signal processor (DSP), an application specific integrated circuit (ASIC), a field programmable gate array (FPGA), or another programmable logic component, transistor logic component, hardware component, or any combination thereof. The processor may also be a combination for implementing computing functions, such as a combination of one or more microprocessors, and a combination of a DSP and a microprocessor.

In an example, the memory may be, for example, a read only memory (ROM), a random access memory (RAM), an electrically erasable programmable read only memory (EEPROM), a compact disc read only memory (CD-ROM) or another optical disk/disc storage (including compact disc, laser disc, optical disc, digital versatile disc, Blu-ray disc, etc.), a magnetic disk storage medium or another magnetic storage device, or any other medium that may be configured to carry or store program codes in the form of instructions or data structures and is capable of being accessed by a computer, which is not limited.

Although the steps in the flowcharts of the accompanying drawings are displayed sequentially as indicated by the arrows, it is to be understood that these steps are not necessarily performed sequentially in the order indicated by the arrows. Unless otherwise specified herein, there is no strict order limitation for performing these steps and these steps may be performed in other orders. In addition, at least part of the steps in the flowcharts of the accompanying drawings may include multiple sub-steps or multiple phases. These sub-steps or phases are not necessarily performed at the same time, but may be performed at different moments. The order of these sub-steps or phases is not necessarily sequential, but may rotate or alternate with at least part of another step or sub-steps or phases of another step.

Although the present disclosure has been illustrated and described with reference to certain examples thereof, it is to be understood by those skilled in the art that various modification in form and details may be made without departing from the scope of the present disclosure. Therefore, the scope of the present disclosure should not be limited to the examples, but should be defined by the appended claims and their equivalents.

1. A communication method for a sensing session setup, comprising:
determining a first message frame, wherein the first message frame comprises capability information on sensing measurement parameters supported by a device performing the communication method; and
transmitting the first message frame.

2. The communication method according to claim 1, wherein the first message frame comprises at least one of the following:
bandwidth information supported by the device,
information on a number of spatial streams supported by the device,
modulation and coding scheme information supported by the device, or
transceiving capability information supported by the device.

3. The communication method according to claim 2, wherein the bandwidth information supported by the device comprises at least one of minimum bandwidth information or maximum bandwidth information supported by the device for a sensing measurement.

4. The communication method according to claim 2, wherein the information on the number of spatial streams supported by the device comprises at least one of a minimum number of spatial streams or a maximum number of spatial streams supported by the device for a sensing measurement.

5. The communication method according to claim 2, wherein the modulation and coding scheme information is associated with the bandwidth information.

6. The communication method according to claim 2, wherein the transceiving capability information supported by the device refers to at least one of 4096-quadrature amplitude modulation (QAM), 1024-QAM, 256-QAM, 64-QAM, 16-QAM, quadrature phase shift keying (QBSK) or binary phase shift keying (BPSK) transceiving capability supported by the device under different resource unit allocations.

7. A communication method for a sensing session setup, comprising:
receiving a first message frame, wherein the first message frame comprises capability information on sensing measurement parameters supported by a device transmitting the first message frame; and
taking one or more operations of a sensing measurement based on the first message frame.

8. The communication method according to claim 7, wherein the first message frame comprises at least one of the following:
bandwidth information supported by the device,
information on a number of spatial streams supported by the device,
modulation and coding scheme information supported by the device, or
transceiving capability information supported by the device.

9. The communication method according to claim 8, wherein the bandwidth information supported by the device comprises at least one of minimum bandwidth information or maximum bandwidth information supported by the device for the sensing measurement.

10. The communication method according to claim 8, wherein the information on the number of spatial streams supported by the device comprises at least one of a minimum number of spatial streams or a maximum number of spatial streams supported by the device for the sensing measurement.

11. The communication method according to claim 8, wherein the modulation and coding scheme information is associated with the bandwidth information.

12. The communication method according to claim 8, wherein the transceiving capability information supported by the device refers to at least one of 4096-quadrature amplitude modulation (QAM), 1024-QAM, 256-QAM, 64-QAM, 16-QAM, quadrature phase shift keying (QBSK) or binary phase shift keying (BPSK) transceiving capability supported by the device under different resource unit allocations.

13-14. (canceled)

15. An electronic device, comprising:
one or more memories,
one or more processors, and
a computer program stored on the one or more memories and executable on the one or more processors,
wherein the one or more processors are configured to:
determine a first message frame, wherein the first message frame comprises capability information on sensing measurement parameters supported by the electronic device; and
transmit the first message frame.

16. A non-transitory computer-readable storage medium, wherein the computer-readable storage medium stores a computer program, and the computer program, when executed by one or more processors, implements the method according to claim 1.

17. An electronic device, comprising:
one or more memories,
one or more processors, and
a computer program stored on the one or more memories and executable on the one or more processors,
wherein the one or more processors, when executing the computer program, implement the method according to claim 7.

18. A non-transitory computer-readable storage medium, wherein the computer-readable storage medium stores a computer program, and the computer program, when executed by one or more processors, implements the method according to claim 7.
